(19) United States
(12) Patent Application Publication
(10) Pub. No.: US 2005/0146256 A1
(43) Pub. Date: Jul. 7, 2005

(54) Storage device for a refrigerator

(75) Inventor: Wolfgang Kaczmarek, Schwindegg (DE)

Correspondence Address: JOHN T. WINBURN, 100 BOSCH BOULEVARD, NEW BERN, NC, 28562, US

(73) Assignee: BSH Bosch und Siemens Hausgerate GmbH, Munich (DE)

(21) Appl. No.: 11/063,344

(22) Filed: Feb. 10, 2005

(30) Foreign Application Priority Data
Aug. 13, 2002 (DE) 102 37 138.5-23
Jul. 24, 2003 (WO) PCT/EP03/08161

(51) Int. Cl. E06B 1/00

(52) U.S. Cl. 312/404; 312/321.5

(57) ABSTRACT

A storage device for mounting in the door of a refrigerator. The storage device includes a base with a pair of side walls, each side wall having a locating groove for mounting on one of a plurality of mounting lugs in a vertical spar of the refrigerator door. The locating groove can accommodate at least one spacer placed in an upper region of the groove for adjusting the spacing of the storage device in the refrigerator door.

The present invention relates to a storage device such as is usually mounted on the inside of the door of refrigerators to accommodate bottles, small items etc. Such a storage device is typically substantially box-shaped with a base, a side wall and locating grooves in the side wall which are provided to cooperate with retaining lugs formed on spars projecting from the inside of the door.

The heights which these storage devices can adopt in a refrigerator are conventionally determined by the position of the retaining lugs on the spars. These generally have a spacing of several centimetres in the vertical so that the spacing of the storage devices one from the other can only be adjusted in coarse steps. If an object to be accommodated in a lower storage device is only a few millimetres larger than the distance from the storage device located thereabove, the latter must be displaced upwards by a complete lug spacing in order to be able to accommodate the object or, if this is possible, removed. Poor usage of the storage space in the refrigerator is the result.

The object of the present invention is to provide a storage device for a refrigerator which makes it possible to economically use the available storage space largely independently of the dimensions of the objects to be stored.

The object is solved by a storage device having the features of claim 1.

By placing the spacer in the upper region of the groove of this storage device, it is achieved that the storage device at a given retaining lug can be mounted higher than without spacers according to the dimensions of the spacer. If an object which requires a slightly larger spacing of the storage devices from one another must be accommodated below the storage device concerned, this can be produced by inserting a spacer in the locating grooves of the upper storage device or if such a spacer is present in the locating grooves of the lower storage device, removing it therefrom.

Each locating groove of the storage device according to the invention advantageously has parallel side flanks and an upper termination which transfers the weight of the storage device onto the locating lugs of the door. This makes it possible to use compact spacers. Naturally, the side flanks of the locating groove can however also run upwards towards one another wherein in this case a spacer with an inverse U- or V-shaped cross-section would be useful.

As a result of a first simple embodiment, the spacer is inserted loosely in the groove and can be removed from the storage device and stored separately when not in use. In order to give such a spacer a secure hold and prevent it from falling out of the locating groove, before the storage device can be placed on the retaining lugs, the spacer can be inserted in the locating groove in a form-locking and/or force-locking fashion perpendicular to the longitudinal direction of the locating groove. In this case, the groove is preferably broadened in the depth direction and the shape of the spacer is matched to this cross-section of the groove.

As a result of a preferred embodiment, the spacers are held horizontally displaceably on the side wall of the storage device. They can thus be displaced from one position in which they engage in the groove into a non-engagement position and back as required.

Alternatively thereto, the spacers can be mounted rotatably about a horizontal axis of rotation in the side wall. This yields a very space-saving arrangement of the spacers in the side wall. In this case, the spacers can be held in their adjustment positions defining different spacings by means of a notch.

It is also advantageous if the spacers each have a stepped lower edge; this allows the spacers to be mounted at different heights each according to one of the steps of the lower edge on the retaining lug. This results in an especially simple handling and manufacture of the spacers, especially when these are made of plastic injection moulding.

The spacers are preferably each guided in a slot between an inner and an outer plate of the side wall and in this way protected from damage and contamination.

More appropriately the spacers should have a handling projection projecting from the slot which makes it possible for the user to displace the spacer in the longitudinal direction of the slot and thereby insert into the locating groove or remove therefrom.

Further features and advantages of the invention are obtained from the following description of exemplary embodiments with reference to the appended figures. In the figures:

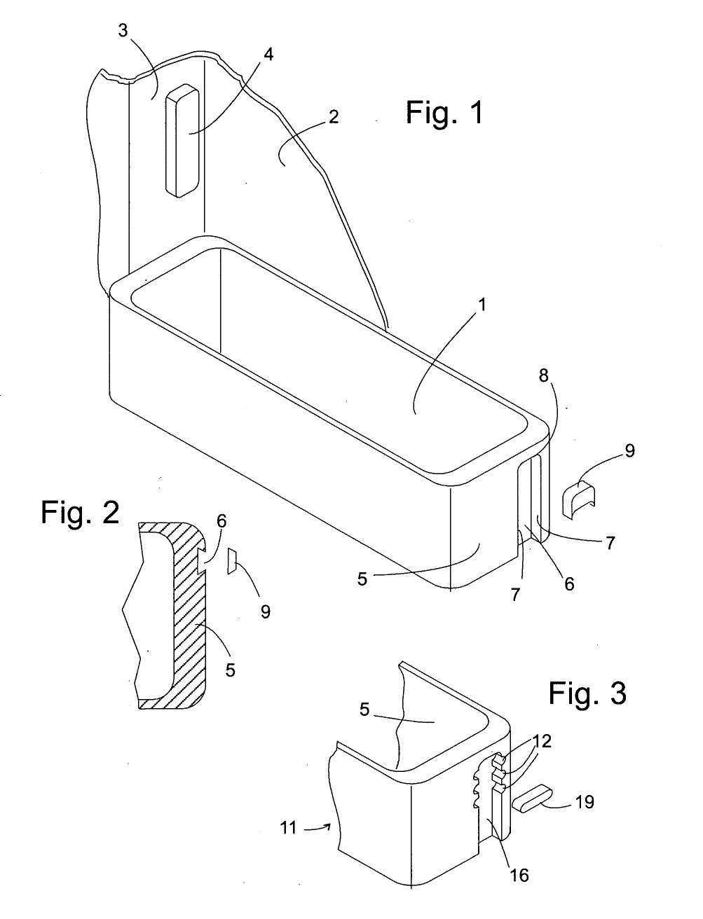

FIG. 1 is a perspective view of a door storage device according to a first embodiment of the invention together with a piece of a door inner wall on which the storage device is held;

FIG. 2 is a section through a side wall of a further developed storage device;

FIG. 3 is a perspective view of an end section of a storage device according to a second embodiment of the invention;

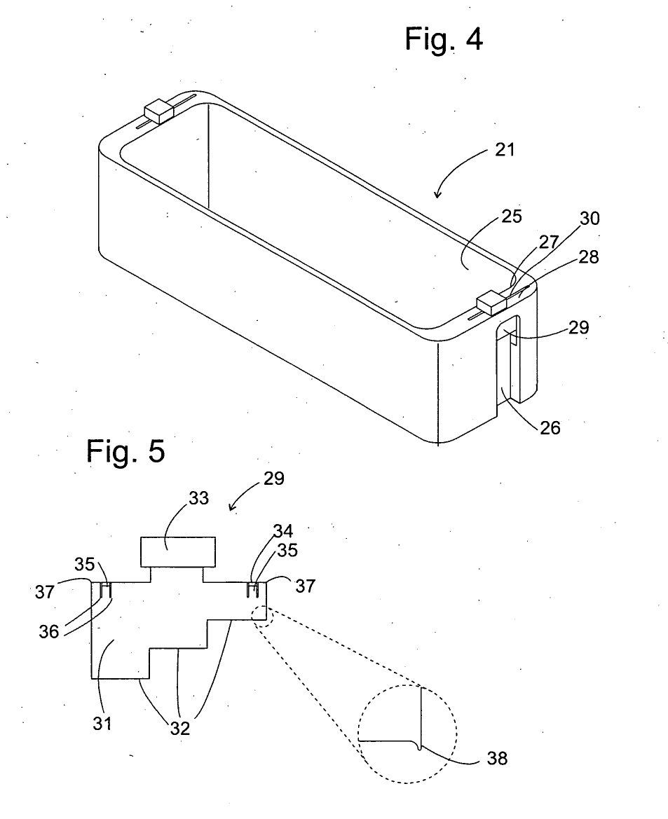

FIG. 4 is a perspective view of an end section of a storage device according to a third embodiment of the invention, with displaceable spacers;

FIG. 5 is a spacer for the storage device from FIG. 4; and

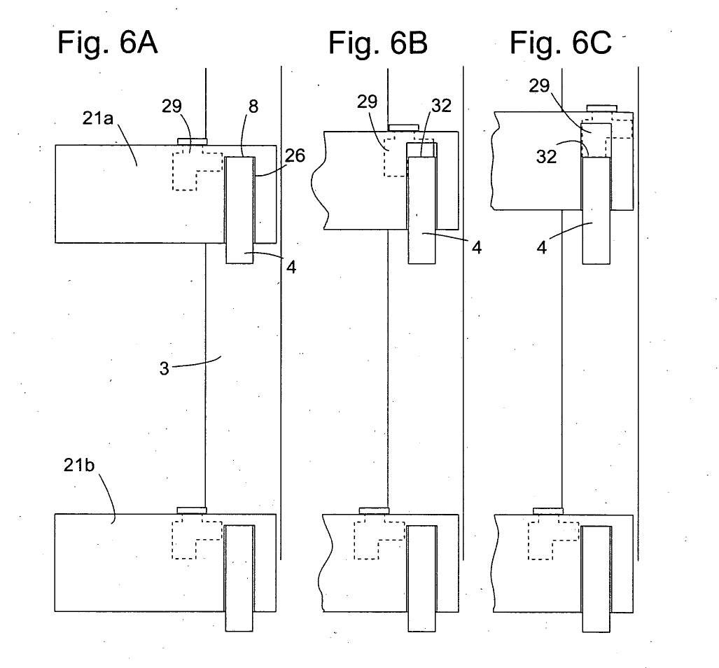

FIG. 6A-C show spacers according to FIG. 4 in different mounting positions.

FIG. 1 shows a perspective view of a door storage device 1 for a refrigerator according to a first embodiment of the invention and a section of an inner wall 2 of a refrigerator door on which the storage device 1 is mounted. On the inner wall 2 two parallel vertical spars 3 project into the interior of the appliance, of which only one is shown in part in the figure. Arranged on the spars 3 are retaining lugs 4 opposite to one another in pairs at a vertical distance of several centimetres. One of these can be seen in the figure and the storage device 1 rests on a second, hidden one. Formed on its side wall 5 matched to the retaining lugs 4 of the spars 3 are locating grooves 6, of which that facing the spar not shown can be seen in the figure. The locating grooves 6 have respectively parallel vertical side flanks 7 and an upper termination 8 which transfers the weight of the storage device 1 onto the retaining lugs 4.

A spacer 9 is shown in front of the locating groove 6. In this embodiment the spacer 9 is a solid body made of rubber or another flexible material which can be inserted in frictional contact into the locating groove 6 in contact with its upper termination 8. If such as spacer 9 is inserted into both locating grooves 6 of the storage device 1, a rest position is obtained for the storage device 1 which is displaced upwards by the height of the spacer 9 with respect to the position which it would adopt without spacers 9.

Thus, the distance of the storage device 1 from a lower-lying storage device (not shown) can be increased as required by inserting spacers 9 if objects placed in the lower-lying storage device require this.

The spacers 9 can be supplied in different heights in order to achieve different height displacements of the storage device 1; however, it is also possible to insert a plurality of identical spacers 9 under one another in the locating grooves 6 of the storage device 1.

FIG. 2 shows a partial section through a further developed modification of the storage device 1 from FIG. 1. The locating groove 6 here has a swallow-tail-shaped cross-section and complementary thereto the cross-section of the spacer 9 is trapezoidal. This modified spacer can only be inserted into the locating groove 6 from below but is better secured against falling out as a result of its cross-sectional shape.

FIG. 3 shows a perspective partial view of a storage device 11 according to a second embodiment of the invention. In this embodiment the locating groove 6 has a plurality of lateral recesses 12 in its upper region and the spacer 19 provided for insertion in the locating groove 16 from the lateral direction has the shape of an oblong bar whose longitudinal ends respectively engage in opposing recesses 12. In this embodiment a single spacer 19 is sufficient to be able to fix the storage device 1 at different heights. In addition, as a result of the section of the locating groove 16 with straight flanks extending below the lowest recesses 12, it is ensured that even in the highest possible mounting position of the storage device 1, this is held stably and securely on the retaining lugs 4 of the door inner wall.

A third embodiment of the storage device according to the invention is explained with reference to FIGS. 4 to 6. FIG. 4 shows a perspective view of the storage device 21. FIG. 5 shows a plan view of one of its spacers 29. The side wall 25 of the storage device 21 is constructed as two-layered at its front sides with an inner plate 27 and an outer plate 28 separated by a slot 30. A locating groove 26 extends through the outer plate 28 as far as the slot 30 and the inner plate 27 is closed.

The spacer 29 is substantially constructed from a flat plate 31 on whose lower edge a plurality of steps 32 are formed, and a slider 33 moulded onto the plate. The spacer 29 is held horizontally displaceably in the slot 30. Its position can be adjusted with the aid of the slider 33. The spacer 29 can adopt a plurality of positions in the slot 30 in which respectively one of the steps 32 is visible in the locating groove 26 and the storage device 21 is supported on a retaining lug of the door. In order to adjust different levels of the storage device 21, it is thus sufficient to displace its spacer 29 such that a desired step 32 is present in the locating groove 26. This is shown in detail in FIGS. 6A to 6C for a spacer with two steps 32. Shown here are respectively one upper storage device 21a and a lower storage device 21b which are mounted one above the other on a spar 3. In FIG. 6A the spacer 29 is withdrawn from the locating groove at both storage devices and the storages devices 21a and 21b each rest with the upper terminations 8 of their locating grooves on the retaining lugs. FIGS. 6B and 6C show the upper storage device 21a with respectively one of the steps 32 of its spacer 29 resting on the retaining lug 4. Naturally at the lower storage device 21b the spacer 29 can also be adjusted in similar fashion in order to reduce the distance between the two storage devices if this is possible or required because of another (not shown) lower lying storage device.

Since the spacers 29 bear the entire weight of the storage device 21 and any objects stowed therein, it must be ensured that they cannot depart upwards from their slot 30. One possibility is to form in the slot 30 a downwardly exposed longitudinal shoulder on which projecting locating lugs 34 bent outwards from the plate 31 transverse to its principal surface can rest. In the exemplary embodiment shown in FIG. 5 these locating lugs 34 are located at the ends of elastic tongues 35 which are separated in the lateral direction from the plate by respectively two short gaps 36. The spacer can be inserted into the slot 30 from above wherein the locating lugs 34 are pressed elastically into alignment with the plate 31 on passing through the slot and then return into their bent position in which they abut against the underside of the shoulder.

Another possibility is to make the slot 30 so short or the spacer 29 so long that in all positions that the spacer 29 can adopt, both upper corners 37 of its plate 31 lie outside the slot and are thus supported on the closed upper side of the side wall. In this solution the slot 30 is open downwards so that the plate 31 can be inserted from below and after inserting the plate 31 the slider 33 is located on a locating section of the plate 31 projecting from the slot 30.

In order to ensure that the spacer 29 does not slip when the storage device 21 is mounted and loaded on a refrigerator door, the inner walls of the slot 30 and the spacer 29 can be provided with detachably engaging locating means or, as shown in the enlarged section in FIG. 5, a small projection 38 can be formed on one corner of each step 32 which respectively grips behind the locating lug 4 and thus prevents lateral slippage of the spacer 29.

1-11. (canceled)

12. A storage device for a refrigerator door, the door including a plurality of retaining lugs in opposite vertical spars in the door, comprising:
a base;
a pair of side walls on opposite sides of said base;
at least one locating groove for mounting onto the retaining lugs in each said side wall; and
at least one moveable spacer which can be placed in an upper region of each said locating grooves for adjusting the spacing of the storage device in the refrigerator door.

13. The storage device according to claim 12, including each said locating groove has substantially parallel side flanks and an upper termination.

14. The storage device according to claim 12, including said spacer is inserted loosely in said locating grooves.

15. The storage device according to claim 12, including said locating grooves have a substantially vertical longitudinal direction and said spacer is inserted in said locating grooves in at least one of a form-locking and a force-locking manner substantially perpendicular to said longitudinal direction of said locating grooves.

16. The storage device according to claim 12, including said locating grooves are broadened in the direction of depth.

17. The storage device according to claim 12, including said spacers are held horizontally displaceably on said side walls.

18. The storage device according to claim 12, including said spacers are arranged rotatably about a horizontal axis of rotation in said side walls.

19. The storage device according to claim 17, including said spacers having a multiple stepped lower edge.

20. The storage device according to claim 17, including said side walls include an inner and an outer plate and a slot there between and said spacers are each guided in said slot.

21. The storage device according to claim 20, including each said slot opening into one of said locating grooves.

22. The storage device according to claim 20, including said spacers each have a handling projection and said handling projection projects from said slot.

23. The storage device according to claim 12, including said spacers are formed from a flexible material.

24. The storage device according to claim 12, including said locating grooves each have a plurality of lateral recesses opposing one another on opposite sides of said grooves and said spacers are formed as an oblong bar whose opposite ends each engage in opposing ones of said lateral recesses.
